(19) United States
(12) Patent Application Publication
(10) Pub. No.: US 2022/0375012 A1
(43) Pub. Date: Nov. 24, 2022

(54) SYSTEM AND METHOD FOR FREEDOM TO OPERATE COMPLIANCE

(71) Applicant: Erich Lawson Spangenberg, Paris (FR)

(72) Inventor: Erich Lawson Spangenberg, Paris (FR)

(21) Appl. No.: 17/692,150

(22) Filed: Mar. 10, 2022

Related U.S. Application Data
(60) Provisional application No. 63/160,604, filed on Mar. 12, 2021.

(51) Int. Cl. G06Q 50/18

(52) U.S. Cl. CPC G06Q 50/184

(57) ABSTRACT

The present invention is a platform of services and solutions for Freedom to Operate compliance and risk mitigation that is AI-enabled and Blockchain-based. IP analytics lower the cost of IP analysis, answering questions to common and complex use cases, enabling for better decision making. The present invention is a risk mitigation solution that provides guidance in the appropriate next steps and how to document them. The present invention covers all necessary steps, from a request for proposal (RFP) to the final product, through launching a landscaping study in parallel to the RFP to assess patent density and competitive metrics, and executing a Freedom to Operate (FTO) search for component versions to implement potential design-arounds to reduce exposure. The present invention documents all efforts and progress in an encrypted blockchain-based repository that is hashed and time-stamped, and FTO reports are periodically updated to reflect current patent coverage.

### PRIORITY CLAIMS

This application claims the benefit of U.S. Provisional Application Ser. No. 63/160,604, filed Mar. 12, 2021, the contents of which are incorporated herein.

### BACKGROUND OF THE INVENTION

This invention relates to Freedom to Operate compliance and risk mitigation.

### SUMMARY OF THE INVENTION

The present invention is a platform of services and solutions for Freedom to Operate compliance and risk mitigation that is AI-enabled and Blockchain-based. IP analytics lower the cost of IP analysis, answering questions to common and complex use cases, enabling for better decision making. IP Management save time and human capital by automating tedious IP workflows to protect and maintain patent assets. IP transactions are much simpler, faster and a far less costly way to buy & sell IP. The present invention incorporates of a Deal Rooms feature that removes barriers and minimizes internal costs when transacting patents. IP consulting provides access to a wealth of knowledge surrounding IP management, strategy, finance and monetization, with unparalleled in-house expertise. The present invention is able to expedite and automate IP analysis, transactions and management.

The current supply chain model is vulnerable to patent threats, wherein suppliers are exposed and become indirect targets. It becomes vital to know when to take the right steps and how to document them by developing a strong risk mitigation strategy. The present invention offers a solution for risk mitigation. The present invention provides convenience through the ability to send and check IP compliance requests in supply chain management (SCM) systems. The present invention also enables flexibility in changing the territorial scope of the assessment.

Vulnerability to exposure within SCM systems results in suppliers becoming indirect targets. This problem can present itself in multiple ways, such as: supply agreement risks; infringement claims; infringement litigation; supplier license requests; and supplier indemnification requests. Risk balance in supply agreements occurs when the end product manufacturer typically requests a guarantee that supplied component is free of third-party rights (e.g., patents) and indemnification in case of infringement claims by a third party against the end product because of a supplied component. Infringement claims and patent litigation typically occurs at the end product level, due to large margins on the end product as a reference point for royalty requests, and leverage created due to the threat of exclusion from the product market.

Infringement litigation operates on tight time frames, and there are many steps that must be completed by the defendant, including: analyzing the infringement allegation; checking the scope of concerned product lines and components (BoMs); reaching out to all concerned suppliers and communicating the technical allegation; waiting for suppliers to respond; assessing the validity of the asserted patent and non-infringement arguments; and aligning with suppliers on a defense strategy with respect to their trade secrets. The defendant has approximately two months to submit the first round of arguments with a statement of defense.

If a relevant patent is detected in a Freedom to Operate search, the supplier can reach out to the patentee and request a license. In specialized areas such as standardized technology (5G, video codecs, etc.) a supplier is likely entitled to an own license. If litigation occurs at the end product level, the supplier faces two challenges: incurring the legal costs for defense support and customer reimbursement; and lack of agency or control as a result of the customer being put under pressure and therefore more likely to settle at unfavorable terms.

The present invention is a risk mitigation solution that provides guidance in the appropriate next steps and how to document them. The present invention covers all necessary steps, from a request for proposal (RFP) to the final product, through launching a landscaping study in parallel to the RFP to assess patent density and competitive metrics, and executing a Freedom to Operate (FTO) search for component versions to implement potential design-arounds to reduce exposure. The present invention documents all efforts and progress in an encrypted blockchain-based repository that is hashed and time-stamped, and FTO reports are periodically updated to reflect current patent coverage.

The present invention provides convenience through the ability to send and check IP compliance requests in SCM-Systems, enables the disclosure of compliance effort to the customer and courts. Courts have increasingly allowed for blockchain-based evidence. The present invention incorporates blockchain technology with monitored application programming interface (API) standards. The present invention uses FTO efforts to provide evidence against allegation of willful infringement in court proceedings, resulting in no punitive damages and avoiding considered injunctions. The present invention offers flexibility through: changing the territorial scope of the assessment; re-routing components and services with ease; providing clear alternative territorial supply routes; extending recorded FTO report to additional countries by checking territorial coverage of detected patents; searching for patents with similar protection; and synchronizing updates automatically with SCM systems.

The present invention's FTO system incorporates a blockchain dashboard with transaction details and blockchain block creation capabilities. The FTO system of the present invention has a products feature that includes: a product data structure; product data storage; single product additions; single product and component creation; linking existing component with product creation; and product creation with existing and new components. The FTO system of the present invention has a components feature that includes: component data structure; component data storage; orphan component creation and duplicate component creation. The FTO system of the present invention also includes: FTO documents; FTO uploading; FTO hashing and FTO access with URL details.

The FTO system of the present invention uses Cloud Object Storage (COS) for document storage. The storage of documents in COS will occur concurrently with storing a hash of the document, but not the document itself, on the World State Ledger, as part of the Solution Design. This document is intended to act as a reference for security analysts as it pertains to IBM Cloud Object Storage. COS offers an array of enhanced security functionality for encrypting files at rest and by default, will encrypt files using randomly generated keys and an all-or-nothing-transform (AONT). This method of default encryption relieves the end-user of any concerns of extra overhead as it pertains to secret key storage, retrieval, and maintenance when it comes to securely encrypting files at rest. In all services that are deployed, following the Solution Design, Hypertext Transfer Protocol Secure (HTTPS) will be enforced to ensure secure transfer while in-transit. The widespread secure version of the HTTP protocol ensures an encrypted link between the two communicating services via SSL/TSL certificate and verification. It will not be possible to send any data in the system unless it is encrypted in-transit. COS offers alternative methods of encrypting files requiring manual management of encryption keys on a per-object basis by providing independent encryption keys. This service is referred to as Server-Side Encryption with Customer-Provided Keys (SSE-C). This option relies on additional overhead for storing and retrieving keys, which can be done by integrating with IBM Cloud Key Management Services.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with various elements as shown.

FIG. 3 is a line diagram illustrating a decentralized network.

FIG. 4 is a line diagram illustrating a distributed network.

FIG. 5 is diagram of the core structure of the platform of the present invention.

FIG. 6 is a diagram of the operational flow of the present invention.

FIG. 7 is a diagram of the detailed operational flow of the present invention.

FIG. 8 is a diagram of the API and data model of the present invention.

### DETAILED DESCRIPTION OF THE PREFERRED EMBODIMENT

The present invention is a platform of services and solutions for Freedom to Operate compliance and risk mitigation that is AI-enabled and Blockchain-based. IP analytics lower the cost of IP analysis, answering questions to common and complex use cases, enabling for better decision making. IP Management save time and human capital by automating tedious IP workflows to protect and maintain patent assets. IP transactions are much simpler, faster and a far less costly way to buy & sell IP. The present invention incorporates of a Deal Rooms feature that removes barriers and minimizes internal costs when transacting patents. IP consulting provides access to a wealth of knowledge surrounding IP management, strategy, finance and monetization, with unparalleled in-house expertise. The present invention is able to expedite and automate IP analysis, transactions and management.

The current supply chain model is vulnerable to patent threats, wherein suppliers are exposed and become indirect targets. It becomes vital to know when to take the right steps and how to document them by developing a strong risk mitigation strategy. The present invention offers a solution for risk mitigation. The present invention provides convenience through the ability to send and check IP compliance requests in supply chain management (SCM) systems. The present invention also enables flexibility in changing the territorial scope of the assessment.

Vulnerability to exposure within SCM systems results in suppliers becoming indirect targets. This problem can present itself in multiple ways, such as: supply agreement risks; infringement claims; infringement litigation; supplier license requests; and supplier indemnification requests. Risk balance in supply agreements occurs when the end product manufacturer typically requests a guarantee that supplied component is free of third-party rights (e.g., patents) and indemnification in case of infringement claims by a third party against the end product because of a supplied component. Infringement claims and patent litigation typically occurs at the end product level, due to large margins on the end product as a reference point for royalty requests, and leverage created due to the threat of exclusion from the product market.

Infringement litigation operates on tight time frames, and there are many steps that must be completed by the defendant, including: analyzing the infringement allegation; checking the scope of concerned product lines and components (BoMs); reaching out to all concerned suppliers and communicating the technical allegation; waiting for suppliers to respond; assessing the validity of the asserted patent and non-infringement arguments; and aligning with suppliers on a defense strategy with respect to their trade secrets. The defendant has approximately two months to submit the first round of arguments with a statement of defense.

If a relevant patent is detected in a Freedom to Operate search, the supplier can reach out to the patentee and request a license. In specialized areas such as standardized technology (5G, video codecs, etc.) a supplier is likely entitled to an own license. If litigation occurs at the end product level, the supplier faces two challenges: incurring the legal costs for defense support and customer reimbursement; and lack of agency or control as a result of the customer being put under pressure and therefore more likely to settle at unfavorable terms.

The present invention is a risk mitigation solution that provides guidance in the appropriate next steps and how to document them. The present invention covers all necessary steps, from a request for proposal (RFP) to the final product, through launching a landscaping study in parallel to the RFP to assess patent density and competitive metrics, and executing a Freedom to Operate (FTO) search for component versions to implement potential design-arounds to reduce exposure. The present invention documents all efforts and progress in an encrypted blockchain-based repository that is hashed and time-stamped, and FTO reports are periodically updated to reflect current patent coverage.

The present invention provides convenience through the ability to send and check IP compliance requests in SCM-Systems, enables the disclosure of compliance effort to the customer and courts. Courts have increasingly allowed for blockchain-based evidence. The present invention incorporates blockchain technology with monitored application programming interface (API) standards. The present invention uses FTO efforts to provide evidence against allegation of willful infringement in court proceedings, resulting in no punitive damages and avoiding considered injunctions. The present invention offers flexibility through: changing the territorial scope of the assessment; re-routing components and services with ease; providing clear alternative territorial supply routes; extending recorded FTO report to additional countries by checking territorial coverage of detected patents; searching for patents with similar protection; and synchronizing updates automatically with SCM systems.

The present invention's FTO system incorporates a blockchain dashboard with transaction details and blockchain block creation capabilities. The FTO system of the present invention has a products feature that includes: a product data structure; product data storage; single product additions; single product and component creation; linking existing component with product creation; and product creation with existing and new components. The FTO system of the present invention has a components feature that includes: component data structure; component data storage; orphan component creation and duplicate component creation. The FTO system of the present invention also includes: FTO documents; FTO uploading; FTO hashing and FTO access with URL details.

The FTO system of the present invention uses Cloud Object Storage (COS) for document storage. The storage of documents in COS will occur concurrently with storing a hash of the document, but not the document itself, on the World State Ledger, as part of the Solution Design. This document is intended to act as a reference for security analysts as it pertains to IBM Cloud Object Storage. COS offers an array of enhanced security functionality for encrypting files at rest and by default, will encrypt files using randomly generated keys and an all-or-nothing-transform (AONT). This method of default encryption relieves the end-user of any concerns of extra overhead as it pertains to secret key storage, retrieval, and maintenance when it comes to securely encrypting files at rest. In all services that are deployed, following the Solution Design, Hypertext Transfer Protocol Secure (HTTPS) will be enforced to ensure secure transfer while in-transit. The widespread secure version of the HTTP protocol ensures an encrypted link between the two communicating services via SSL/TSL certificate and verification. It will not be possible to send any data in the system unless it is encrypted in-transit. COS offers alternative methods of encrypting files requiring manual management of encryption keys on a per-object basis by providing independent encryption keys. This service is referred to as Server-Side Encryption with Customer-Provided Keys (SSE-C). This option relies on additional overhead for storing and retrieving keys, which can be done by integrating with IBM Cloud Key Management Services.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

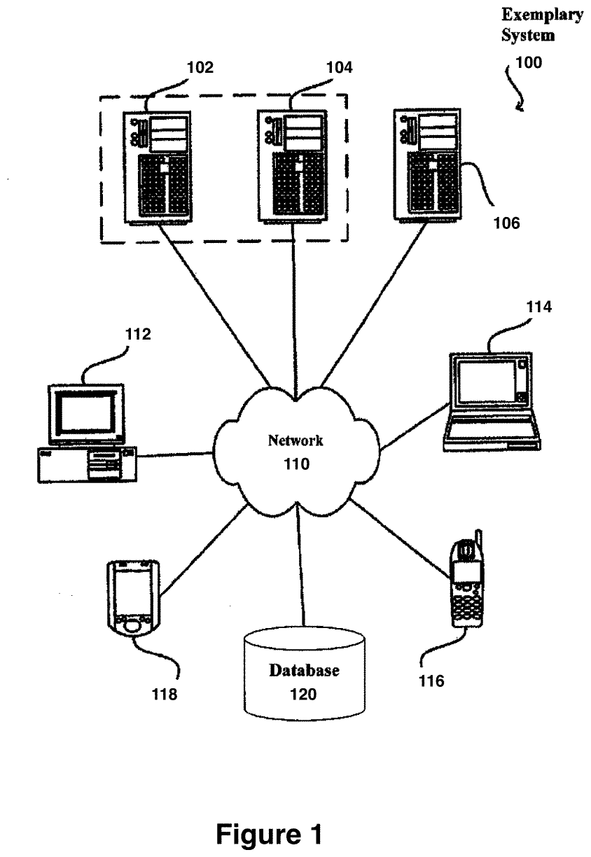

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet-enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java.®., C, C# or C++, and/or any scripting language, such as Perl, Python, or TCL, as well as combinations of any programming/scripting languages. The server(s) may also include database servers, including without limitation those commercially available from Oracle.®., Microsoft.®., Sybase.®., IBM.®. and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10g, that is adapted to store, update, and retrieve data in response to SQL-formatted commands.

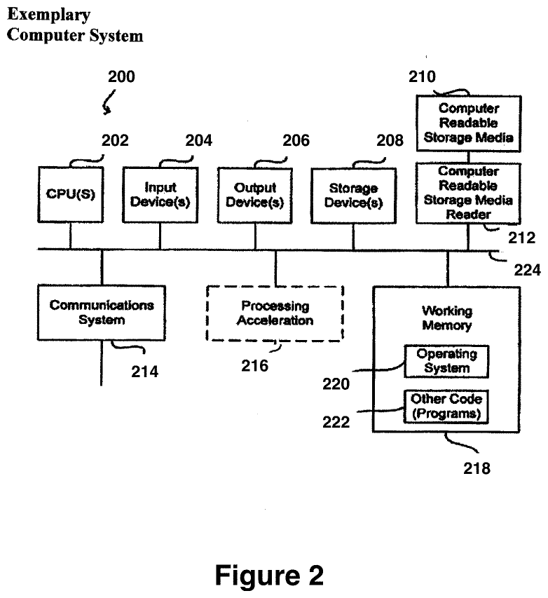

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium.®. processor or the like. Similarly, a computer system (and additional instances of an enterprise database, where more than one is present) and all of their components might be operator configurable using application(s) including computer code run using a central processing unit such as an Intel Pentium.®. processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java.™., JavaScript, ActiveX, any other scripting language such as VBScript, and many other programming languages as are well known. (Java.™. is a trademark of Sun Microsystems, Inc.).

The present invention utilizes key aspects of blockchain technology. Blockchain technology uses digital fingerprints, version control and a distributed ledger to provide an immutable notary through a distributed asset ledger. Digital fingerprints incorporate time stamps on files to eliminate potential file tampering. Version control provides a means of connecting multiple iterations of files together using the same fingerprints. A distributed ledger provides a secure means of recording an immutable record to facilitate the transfer of funds between parties. Blockchain technology provides enterprise transaction support through smart contracts and a permission ledger. Smart contracts provide a means of attaching events and conditions to a transaction on the distributed ledger, and a permission ledger applies technology to global business transactions with privacy and better performance. Blockchain technology acts as a network of networks within a market, resulting in building trusted data and networks that operate at the level of the market.

By applying blockchain technology at the market level, the present invention transforms how IP assets are obtained, managed and transacted. Permissioned Blockchain allows multiple competing parties to operate from the same common database without revealing their data to the other party via the following means: trust, as the ledger keeps an immutable record of IP assets with rules governing who can update the records & how; control, as no central authority has access to all data on the network, the network is instead governed by rules; and privacy, through data and events that are made private and are both invisible and inaccessible to users who do not have authorization.

The present invention transforms how IP is obtained, managed and transacted by applying blockchain technology at the market level. Through blockchain technology, the present invention captures all IP asset events, whereby every party works from same record and titles are tracked. Each event for an IP asset is written to the blockchain, and rules dictate what data can be updated & how. All parties work from the same IP asset record and each change in ownership is a blockchain event. Parties have a secure environment where they can interact & transact on IP assets through: a private network channel for parties to interact; management of activity for both parties within the same location; data that can be shared safely over a private network; and paper contracts automated through smart contracts.

The permissioned blockchain network of the present invention fosters trust and globally improves cross border transactions. The blockchain network can be deployed globally, and only verified members are given access to the network. All parties can connect to a single platform and blockchain removes cross border cost & complexity. The present invention utilizes blockchain technology to capture the invention and introduce flexibility in how IP is stored & protected. Blockchain provides proof of inventorship and set up partnerships earlier once application is filed. Research is connected to the final patent and the present invention provides a secure platform for R&D and IP to work more closely.

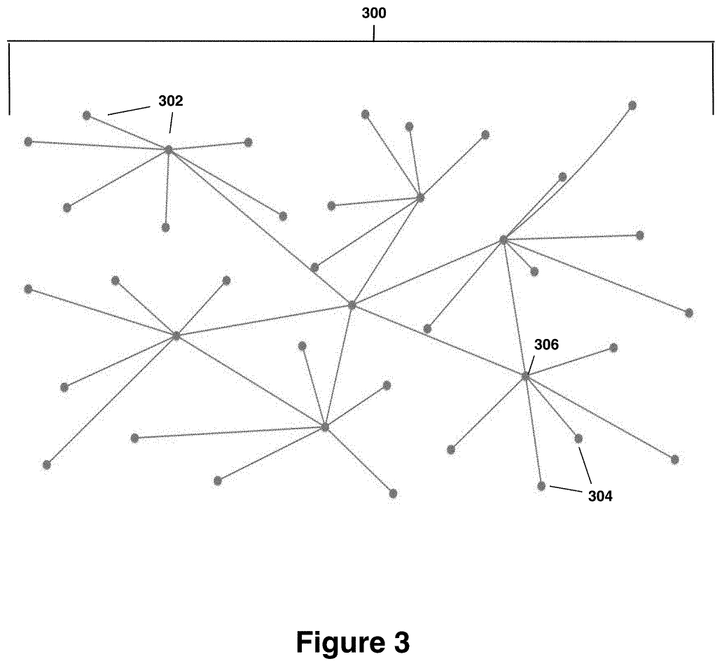

FIG. 3 is a line diagram illustrating a decentralized network. In accordance with the preferred embodiment of the present invention, the specific architecture of the network can be either decentralized or distributed. FIG. 3, generally represented by the numeral 300, provides an illustrative diagram of the decentralized network. FIG. 3 depicts each node with a dot 302 Under this system, each node is connected to at least one other node 304. Only some nodes are connected to more than one node 306.

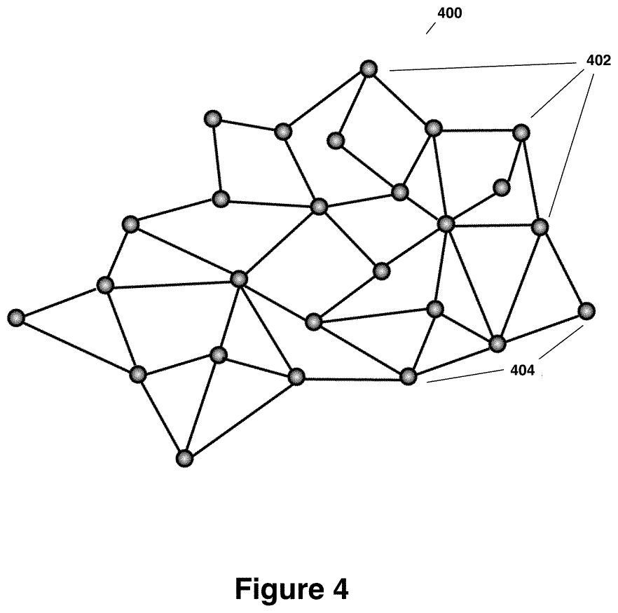

FIG. 4 is a line diagram illustrating a distributed network. For comparison purposes, FIG. 4, which is generally represented by the numeral 400, illustrates a distributed network. Specifically, the illustration shows the interconnection of each node 402 in a distributed decentralized network 400. In accordance with the preferred embodiment of the present invention, each node 402 in the distributed network 400 is directly connected to at least two other nodes 404. This allows each node 402 to transact with at least one other node 402 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

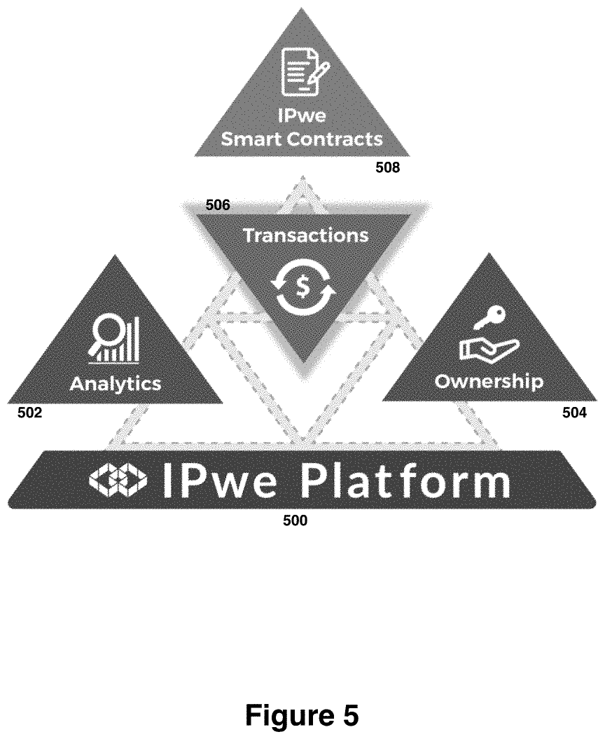

FIG. 5 is diagram of the core structure of the platform of the present invention. In accordance with the preferred embodiment of the present invention, the platform 500 is based on the core aspects of: an analytics engine 502; IP ownership 504; transactions 506; and smart contracts 508. The analytics engine 502 leverages the power of artificial intelligence to provide answers to basic and complex questions about patents, and is available free of charge on the Platform 500. The analytics engine 502 delivers immediately actionable insights and offers a suite of integrated and powerful tools unmatched in sophistication and proven results. The ownership aspect 504 is based on the Global Patent Registry (GPR), which is the first and only blockchain-enabled registry of the world's patents that provides full transparency into patent identification and ownership 504. The GPR is available free of charge and currently includes information for over 80% of the world's patents. The Smart Contracts feature 508 is implemented on Hyperledger by the world's leading experts on patent transactions. Developing smart contracts 508 for IP transactions requires a competence and expertise in blockchain and patents that few possess and even fewer can implement. The smart contracts feature 508: results in transactional 506 efficiencies and lower costs; reduces human resource requirements; promotes standardization; and acts as a built-in contract management tool.

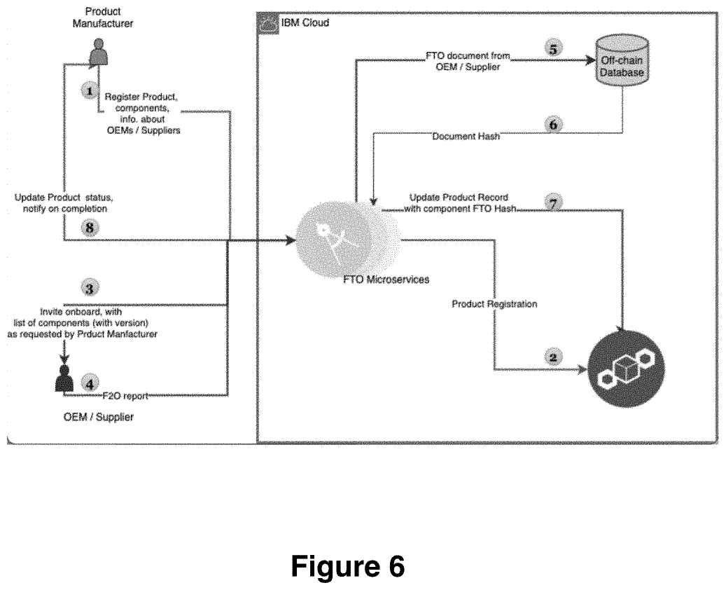

FIG. 6 is a diagram of the operational flow of the present invention. In accordance with the preferred embodiment of the present invention, the operational flow functionality requirements of the present invention starts with registration & on-boarding of original equipment manufacturers (OEMs), original design manufacturers (ODMs) & wholesalers, as well as registration of products. Product registration can encompass multiple product versions, each version with multiple components and each component with multiple suppliers. FTO reports are uploaded for each product version, component and supplier, along with all associated metadata. FTO also includes auditability, reporting and validation. The present invention uses functional Blockchain solution capabilities that are a membership consortium that includes: the platform of the present invention; OEMs, ODMs and wholesalers; and arbitrators. The present inventions FTO blockchain is API based (with no user interface) and can include: on-chain, Off-chain, and hashing; supporting bulk and single file data uploads; and offering confidentiality, security and privacy.

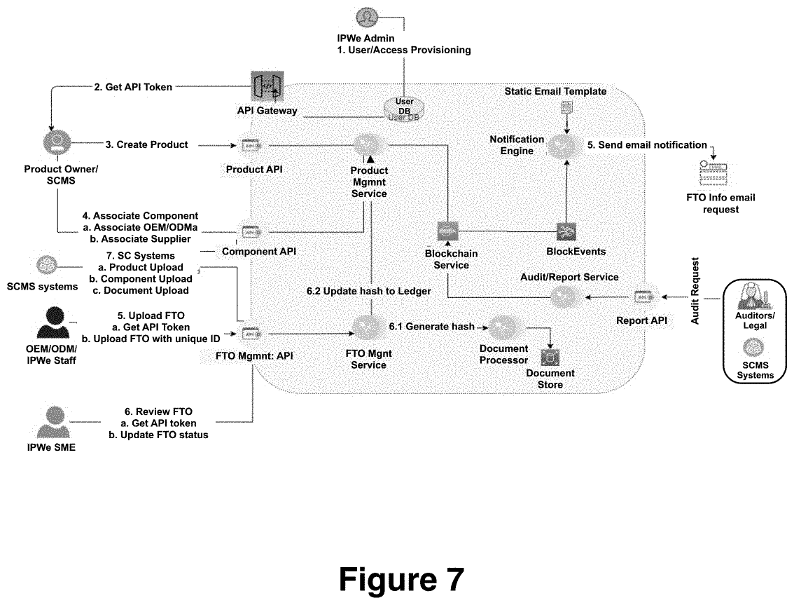

FIG. 7 is a diagram of the detailed operational flow of the present invention. In accordance with the preferred embodiment of the present invention, the present invention's FTO capabilities are enabled through: FTO supplier and product management; FTO management; notifications; and reports. FTO supplier & product management consists of: user access control & permissions; API to on-board OEM, ODM, and wholesalers (individual); product upload via API; mapping products & associated components; mapping of components to OEM, ODM, and wholesalers (individual); queries based on product or component unique ID; and product components which can be supplied by one OEM, ODM or supplier. Suppliers can be associated with multiple product components. FTO management consists of: API to upload multiple version of FTO document with off-chain storage; associating FTO with components; associating FTO with products; FTO status management; and FTO workflow management. Notifications consist of: FTO workflow notifications; supplier notifications; and emails with static templates and log entries. Reports consist of pdf reports on FTO document URL that is list based on the product or component ID, and offline manual audit history reports that can be in pdf, csv, or have query results and interactive capability options.

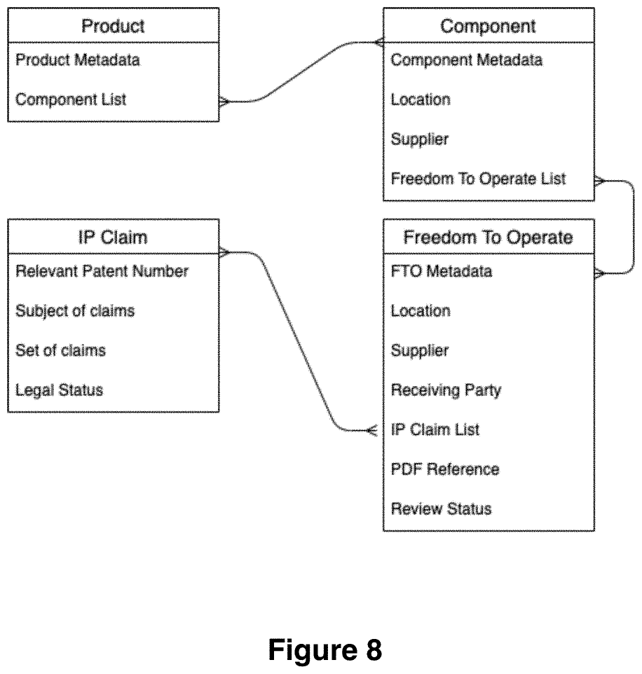

FIG. 8 is a diagram of the API and data model of the present invention. In accordance with the preferred embodiment of the present invention, the FTO API and data model consists of products that include all product metadata and component lists. The product section is linked with the component section, which consists of component metadata, location and supplier data, and a Freedom to Operate (FTO) list. The component section is linked to the FTO section, which consists of: FTO metadata location and supplier data; receiving party data; IP claim lists; PDF reference documents; and review status. The FTO section is linked to the IP claim section, which consists of: the relevant patent number; the subject of the claim; the set of claims; and the legal status of the IP.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”

What is claimed is:

1. A system for providing freedom to operate compliance and risk mitigation, the system comprising:
at least one hardware processor, a non-transitory machine-readable storage medium having an executable computer readable program code, the at least one hardware processor configured to execute the computer-readable program code to:
access a plurality of databases, at least one of the plurality of databases containing patent related information;
search on at least one of the plurality of databases; and
receiving, using a processor and memory, a customer inquiry, wherein the customer inquiry includes data indicative of automated IP analysis, transactions and management services.
